(19) United States
(12) Patent Application Publication
(10) Pub. No.: US 2009/0325023 A1
(43) Pub. Date: Dec. 31, 2009

(54) Repetition Unit for a Stack of Electrochemical Cells, Stack Arrangements And Method for Production of Repetition Unit

(76) Inventors: Mihails Kusnezoff, Dresden (DE); Alexander Michaels, Dresden (DE); Michael Stelter, Rohrsdorf (DE)

Correspondence Address: GIBSON & DERNIER L.L.P., 900 ROUTE 9 NORTH, SUITE 504, WOODBRIDGE, NJ, 07095, US

(21) Appl. No.: 12/376,406

(22) PCT Filed: Aug. 23, 2007
(86) PCT No.: PCT/DE07/01540

§ 371 Date: Mar. 25, 2009

(30) Foreign Application Priority Data
Aug. 23, 2006 (DE) 1020060400030.5

(51) Int. Cl. H01M 8/10; C25B 9/00; H01M 4/00; H01M 2/02; B23K 1/20

(52) U.S. Cl. 429/30; 204/267; 429/40; 429/34; 228/248.1

(57) ABSTRACT

The present invention relates to a repetition unit for a stack of electrochemical cells comprising a cathode-electrolyte-anode unit as well as a first layer and at least one further layer of an interconnector plate contacting it, wherein the first layer is made from sheet metal and is in electrical contact with the cathode-electrolyte-anode unit, while the at least one further layer is omitted in an active region, wherein furthermore the at least one further layer comprises an unshaped planar material and the first layer is also unshaped in a marginal region surrounding the active region and the cathode-electrolyte-anode unit and wherein all the named layers of the interconnector plate are soldered to one another in the marginal region. The invention furthermore relates to a corresponding stack arrangement of electrochemical cells as well as to a method for the manufacture of such a repetition unit.

The present invention relates to a repetition unit for a stack of electrochemical cells which includes a cathode-electrolyte-anode unit as well as a first layer of an interconnector plate contacting the cathode-electrolyte-anode unit and at least one further layer of the interconnector plate in accordance with the preamble of claim 1. The invention furthermore relates to a stack arrangement of electrochemical cells including at least two such repetition units and to a method for the manufacture of such a repetition unit.

In a generic repetition unit, the first layer of the interconnector plate is made from electrically conductive material and is in electrical contact with the cathode-electrolyte-anode unit, with the at least one further layer being omitted in an active region of the corresponding electrochemical cell which can be a fuel cell or also an electrolysis cell. Such repetition units are typically combined to form a stack in which the repetition units are arranged sequentially in a stack direction. The interconnector plates then arranged between sequential electrochemical cells serve an electron transport between an anode of an electrochemical cell and a cathode of a subsequent electrochemical cell. Such a stack is normally terminated by two end plates (top plate and base plate) from which in the case of a fuel cell stack an electron current for an external circuit can be picked up.

Generic repetition units are known, for example, from the document DE 100 44 703 A1. In comparison with conventional fuel cell units with interconnector plates which comprise eroded or milled metallic full plates for the formation of a passage structure for operating means (combustion gas and oxidant), a repetition unit of the kind proposed in the named document should be able to be manufactured with less effort and/or cost. It has, however, been shown that the layers of the interconnector plate of such a repetition unit in accordance with the prior art warp on the connection of the layers so that they have to be annealed in an additional step and have to be shaped back into a planoparallel state.

It is now the underlying object of the present invention to provide a comparable repetition unit which can be manufactured even more simply in that such an additional method step becomes superfluous. It is furthermore the object of the invention to provide a corresponding manufacturing method for a repetition unit and a stack arrangement of electrochemical cells which can be manufactured with an accordingly low effort.

This object is solved in accordance with the invention by a repetition unit having the characterizing features of claim 1 in conjunction with the features of the preamble of claim 1 as well as by a stack arrangement having the features of claim 12 and a method having the features of claim 13. Advantageous embodiments and further developments of the invention result from the features of the dependent claims.

A particularly simple manufacturing capability of the proposed repetition unit results in that the at least one further layer of the interconnector plate is made from an unshaped planar material, with the first layer—made from an electrically conductive material such as sheet metal—of the interconnector plate in a marginal region surrounding the active region also therefore being unshaped, that is, planar and the cathode-electrolyte-anode unit as well as all the named layers of the interconnector plate being soldered to one another in the marginal region. The further layer of the interconnector plate can in typical embodiments of the invention be arranged between the named first layer and the cathode-electrolyte-anode unit. Preferred embodiments of the invention provide that a further layer of the interconnector plate is additionally arranged on a side of the first layer of the interconnector plate remote from the cathode-electrolyte-anode unit. Alternatively or additionally, a layer of a next interconnector plate typically omitted in the active region can be arranged on a side of the cathode-electrolyte-anode unit which is remote from the previously named layers, which is formed from an unshaped planar material and is soldered to the cathode-electrolyte-anode unit in the marginal region. A deformation during soldering caused by different thermal coefficients of expansion of the layers of the interconnector plate and of the cathode-electrolyte-anode unit can thereby be prevented even better.

The corresponding advantageous method for the manufacture of such a repetition unit provides that a solder paste is applied respectively to at least one of two later mutually contacting surfaces of two layers of the interconnector plate or of the cathode-electrolyte-anode unit and an interconnector plate layer, after which the named layers and the cathode-electrolyte-anode unit are preinstalled by placing onto one another and possible pressing on, with the named layers and the cathode-electrolyte-anode unit subsequently being soldered to one another by a common heating. In this respect, a respective metal solder and/or a glass solder can be used as the solder paste so that mutually following layers of the interconnector plate or the cathode-electrolyte-anode unit and the layer contacting it are each connected to one another by glass solder and/or metal solder respectively. The preinstallation can take place most simply at room temperature. For the soldering, the named layers can be heated as a whole in a furnace with the cathode-electrolyte-anode unit, with the soldering preferably taking place by annealing at a temperature of between 600° C. and 1100° C.

The cathode-electrolyte-anode unit typically includes a cathode layer, an electrolyte layer and an anode layer as well as additionally any porous metal layer serving as a carrier. Instead of such a metal layer, however, the cathode layer, the electrolyte layer or the anode layer itself can also serve as the carrier stabilizing the cathode-electrolyte-anode unit. The electrolyte layer is provided by a solid electrolyte membrane in typical embodiments of the invention, with the corresponding electrochemical cells being able to be high-temperature fuel cells which have operating temperatures of above 500° C., preferably operating temperatures of above 600° C. In particular various oxides are suitable as solid electrolytes. A corresponding high-temperature fuel cell is also called an SOFC (solid oxide fuel cell). On a manufacture of repetition units for such high-temperature fuel cells, the advantage of the present invention is in particular realized because very high temperatures are also required for the manufacture of corresponding repetition units, which in turn makes a prevention of deformations difficult which are avoidable with the present invention.

A conductive porous contact element can be provided between the first layer of the interconnector plate and the cathode-electrolyte-anode unit which contacts the two and communicates an electrical contact between the two. A corresponding contact element can also be arranged at and contacting a side of the cathode-electrolyte-anode unit remote from the first layer of the interconnector plate to communicate an electrical contact to an interconnector plate of a next repetition unit. Such a contact element can therefore contact the cathode-electrolyte-anode unit, more precisely the anode layer or the cathode layer, respectively at the anode side or at the cathode side. In addition to the electrical contact between the anode layer or the cathode layer respectively and the contacting interconnector plate, such a contact element allows a flowing through of a reactant gas or of a reaction product even when the first layer of the interconnector plate communicating an electrical contact to a next electrochemical cell does not itself have any passage structure. The first layer of the interconnector plate can therefore comprise a completely unshaped, completely planar metal sheet—the same also applies to any further throughgoing layers of the interconnector plate present. A particularly low-effort manufacture and a particularly efficient avoidance of deformations during soldering thereby result.

The named porous contact element can be made in preferred embodiments of the invention from nickel foam, which is particularly conductive and corrosion-resistant, or from another porous metal substrate or an advantageously temperature-resistant cermet substrate (ceramic-metal mixture). Such a contact element can, for example, be manufactured by cast film extrusion and subsequent sintering. In another embodiment of the invention, the contact element can also be made from a mesh wire which is here also called porous. On the manufacture of the repetition unit, such a contact element can preferably be welded (preferably by spot welding) or soldered to the cathode-electrolyte-anode unit or to a layer—typically the first layer—of the interconnector plate before the placing onto one another of the layers and of the cathode-electrolyte-anode unit. Instead, the contact element can also only be loosely inserted into a hollow space between the cathode-electrolyte-anode unit and the first layer of the interconnector plate.

Like the first layer of the interconnector plate, the at least one further layer can also be made of sheet metal, preferably of particularly low-corrosion steel. When the different layers of the interconnector plate are made from a single material, deformations can be avoided particularly easily. Provision can, however, also be made that the at least one further layer of the interconnector plate is made from ceramic material—the same applies to a possibly present layer of a next interconnector plate on an oppositely disposed side of the cathode-electrolyte-anode unit. A thermally particularly stable structure and a desirably good electrical insulation in the marginal region between the different layers thereby result. Typical embodiments of the invention provide that the different layers of the interconnector plate have a respective thickness of between 0.1 mm and 1 mm. Repetition units having interconnector plates dimensioned in this manner are in particular suitable for the manufacture of portable SOFC stacks or other portable stacks of electrochemical cells.

Both the cathode-electrolyte-anode unit and the layers of the interconnector plate usually have cut-outs in the marginal region for a reactant supply or a reaction product drainage. A combustion gas such as hydrogen thus has to be supplied at an anode side of the cathode-electrolyte-anode unit and an oxidant such as air or oxygen has to be supplied at a cathode side. Water is to be drained as the reaction product, for example, in the case of a typical SOFC with an anion conductive electrolyte membrane at the anode side. A corresponding reactant supply and reaction product drainage can be realized in a simple manner by different cut shapes of the layers of the interconnector plate. In the marginal region of the cathode-electrolyte-anode unit and of the layers of the interconnector plate, cut-outs can moreover be provided for anchors, preferably in a corner in each case, which can serve for the holding together of a corresponding stack of a plurality of repetition units. Such cut-outs can, also like a cut-out of layers of the interconnector plate in the active region, be realized in that they are punched out or cut out before the installation of the repetition unit, in a particularly simple manner, for example, by laser cutting or by electron beam cutting.

The feature named further above of a use of unshaped planar sheet metals or materials for the layers of the interconnector plate is not to be understood as a contradiction of a possible punching out or cutting out of recesses or cut-outs, but as a dispensing with a shaping process of the named materials where they are not cut out. The term soldering is in turn, as also results from the above, generally to be understood such that it also includes glass soldering. It is also unproblematic if a solder is used with a melting temperature which is in the range of an operating temperature of the electrochemical cells.

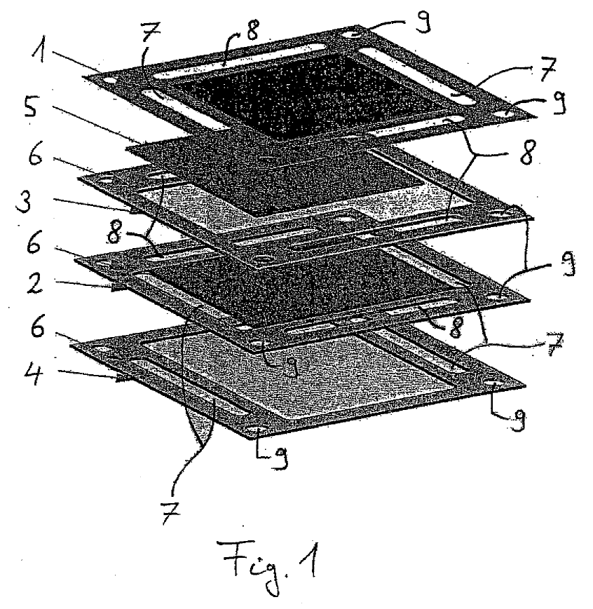

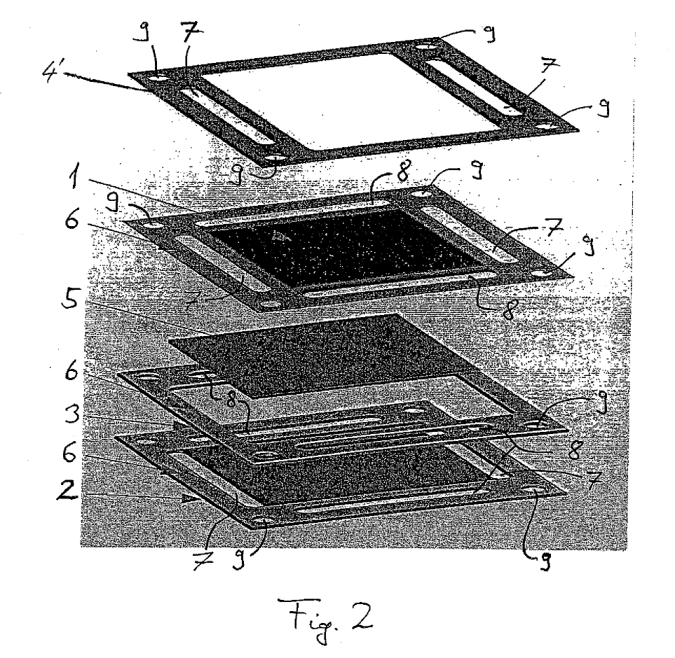

Embodiments of the present invention will be described in the following with reference to FIGS. 1 and 2. There are shown

FIG. 1 an exploded representation of a repetition unit in accordance with the invention for a stack of electrochemical cells; and

FIG. 2 a corresponding representation of a repetition unit in another embodiment of the invention.

FIG. 1 shows as components of a repetition unit for a stack of high-temperature fuel cells, more precisely for an SOFC stack, a cathode-electrolyte-anode unit 1 which, beside a solid electrolyte membrane as an electrolyte layer, has a cathode layer at an upper side and an anode layer at a lower side; a first layer 2 of an interconnector plate punched out of a planar metal sheet or cut to size by laser cutting or electron beam cutting; as well as a further layer 3 of the interconnector plate arranged between the cathode-electrolyte-anode unit 1 and the first layer 2 and an additional further layer 4 of the interconnector plate which is arranged on a side of the first layer 2 remote from the cathode-electrolyte-anode unit 1. The further layers 3 and 4 of the interconnector plate are omitted in an active region, i.e. in a region which is in alignment with an active region of the corresponding electrochemical cell and, like the first layer 2, comprise unshaped planar sheet metal. The further layers 3 and 4 can also instead be made of planar ceramic layers. A hollow space formed by the omission of the further layer 3 in the active region between the cathode-electrolyte-anode unit 1 and the first layer 2 accepts a conductive porous contact element 5 which communicates an electrical contact between the anode layer of the cathode-electrolyte-anode unit 1 and the first layer 2 of the interconnector plate and simultaneously allows a flowing through of reactants to be supplied and reaction products to be drained. A corresponding contact element can also be provided on a side of the first layer 2 remote from the cathode-electrolyte-anode unit 1 and can, like the contact element 5, be connected to the first layer 2 by spot welding under certain circumstances.

In a marginal region surrounding the active region, the cathode-electrolyte-anode unit 1 and the layers 2, 3 and 4 of the interconnector plate are soldered to one another. For this purpose a solder paste 6, which can be a metal solder and/or a glass solder, is applied respectively to an upper side of the first layer 2 and of the further layers 3 and 4 of the interconnector plate.

In the manufacture of the repetition unit shown in FIG. 1, the solder paste 6 is first applied in the marginal region of the layers 2, 3 and 4 of the interconnector plate, after which the named layers 2, 3 and 4 with the contact element 5 and the cathode-electrolyte-anode unit 1 are placed over one another and are preinstalled, after which an ensemble created in this way is heated completely in a furnace to a temperature of between 600° and 1100° C. and is thus soldered to each other by annealing. In this respect, the contact element 5 and any present further contact element not shown in FIG. 1 can also be soldered to the cathode-electrolyte-anode unit or to the first layer 2 of the interconnector plate.

The porous contact element 5 comprises a nickel foam. In other embodiments of the invention, the contact element 5 can also be made of another porous metal substrate, of a cermet substrate or of a wire mesh. The same applies to a possibly present additional contact element at a lower side of the first layer 2 for the contacting of a cathode side of an adjacent repetition unit. In particular cast film extrusion and subsequent sintering is suitable for the manufacture of the contact element 5 and corresponding further contact elements.

In the marginal region, the cathode-electrolyte-anode unit 1, the first layer 2 and the further layer 4 have elongate cut-outs 7 for the supply of a combustion gas, preferably of hydrogen, into a plane defined by the further layer 3 and for the drainage of a reaction product, typically of water, from this plane which defines an anode side of the cathode-electrolyte-anode unit 1. For the supply of an oxidant which can be provided by air or oxygen and for the drainage of excess oxidant gas, the cathode-electrolyte-anode unit 1, the further layer 3 and the first layer 2 accordingly have second elongate cut-outs 8 in remaining regions of the marginal region through which a supply of the oxidant into a plane which is defined by the further layer 4 becomes possible and which defines a cathode side of a further repetition unit which is adjacent—after formation of a stack of a plurality of such repetition units. In addition, a respective round cut-out 9 is provided in four corners both of the cathode-electrolyte-anode unit 1 and of the layers 2, 3 ad 4 of the interconnector plate, said cut-out allowing a clamping of a stack formed from a plurality of such repetition units using four anchors. Such a stack typically includes a plurality of repetition units of the type depicted which can additionally be adhesively bonded or soldered to one another under certain circumstances.

The cut-outs 7, 8 and 9 in the cathode-electrolyte-anode unit 1 and in the layers 2, 3 and 4 of the interconnector plate have previously been cut-out or punched out; in the case of the layers 2, 3 and 4 from planar sheet metal cuts of a thickness of approximately 0.5 mm. The cathode-electrolyte-anode unit 1 is electrolytically carried in the present embodiment. However, cathode-carried or anode-carried cathode-electrolyte-anode units would also be conceivable or also those which have their own carrier layer with a porous metal substrate.

In the repetition unit shown in FIG. 2, the same features are again provided with the same reference numerals. A difference to the embodiment of FIG. 1 only results in that, instead of the further layer 4 of the interconnector plate which forms the bottommost layer of the repetition unit in FIG. 1, here a corresponding further layer 4′ of an interconnector plate is provided whose other layers belong to a further corresponding repetition unit which, in the case of a stack formation, is placed at the top onto the repetition unit shown in FIG. 2. The layer 4′ of this next interconnector plate is in the present case soldered to the cathode-electrolyte-anode unit 1 contacting at the cathode side. Solder paste 6 is applied in this embodiment respectively in the marginal region to an upper side of the first layer 2 and of the further layer 3 as well as to the cathode-electrolyte-anode unit 1.

The cathode-electrolyte-anode unit 1 in the embodiment shown in FIG. 2 is therefore clamped at both sides between two interconnector metal sheets, namely between the further layer 3 and the layer 4′ belonging to the next interconnector plate, whereby a bending of the repetition unit in manufacture due to different coefficients of expansion of the metal sheets and the cathode-electrolyte-anode unit can be avoided even better.

The embodiment from FIG. 2 therefore also shows a schematic design of a repetition unit for portable high-temperature fuel cells. The repetition unit again has an electrolytically borne cathode-electrolyte-anode unit 1 with an air or oxygen electrode on the upper side. The electrolyte layer of this cathode-electrolyte-anode unit 1 is prefabricated so that it includes the openings or cut-outs 7 and 8 for the combustion gas and air supply to the electrodes. The correspondingly cut metal sheets with a thickness of 0.5 mm form the interconnector (the interconnector plate) in the finished stack. The solder plate 6 is, as also in the embodiment from FIG. 1, applied by screen printing and realizes the connection between the layers 2, 3 and 4′ as well as the cathode-electrolyte-anode unit 1 by a solder process. The contact element 5, only an anode contact element is again shown, is again manufactured from nickel foam or from a nickel fleece and is mechanically and electrically connected to the first layer 2 of the interconnector by spot welding.

1. A repetition unit for a stack of electrochemical cells, comprising:
a cathode-electrolyte-anode unit; and
a first layer and at least one further layer of an interconnector plate contacting the cathode-electrolyte-anode unit, where the first layer of the interconnector plate is made from electrically conductive material and is in electrical contact with the cathode-electrolyte-anode unit, while the at least one further layer is omitted in an active region,
wherein the at least one further layer is formed from an unshaped planar material, whereby the first layer of the interconnector plate also being unshaped at least in a marginal region surrounding the active region and the cathode-electrolyte-anode unit as well as all the layers of the interconnector plate being soldered to one another in the marginal region.

2. A repetition unit in accordance with claim 1, wherein the cathode-electrolyte-anode unit includes a solid electrolyte membrane for a high-temperature fuel cell.

3. A repetition unit in accordance with claim 1, wherein a conductive porous contact element is arranged contacting an anode side and/or a cathode side of the cathode-electrolyte-anode unit for the communication of an electrical contact between the cathode-electrolyte-anode unit and the first layer of the interconnector plate or of an interconnector plate of a next repetition unit.

4. A repetition unit in accordance with claim 3, wherein the porous contact element is made from nickel foam, from another porous metal substrate, from a cermet substrate or from a wire mesh.

5. A repetition unit in accordance with claim 1, wherein the first layer of the interconnector plate is made from an unshaped metal sheet and is completely planar.

6. A repetition unit in accordance with claim 1, wherein the at least one further layer is made of sheet metal or of ceramic material.

7. A repetition unit in accordance with claim 1, wherein sequential layers of the interconnector plate as well as the cathode-electrolyte-anode unit and the at least one further layer of the interconnector plate contacting it are connected to one another by glass solder and/or by metal solder.

8. A repetition unit in accordance with claim 1, wherein the layers of the interconnector plate and the cathode-electrolyte-anode unit have cut-outs for a reactant supply or a reaction product drainage in the marginal region.

9. A repetition unit in accordance with claim 1, further comprising at least one layer of a next interconnector plate omitted in the active region arranged on a side of the cathode-electrolyte-anode unit remote from the interconnector plate which is made from an unshaped planar material and is soldered to the cathode-electrolyte-anode unit in the marginal region.

10. A repetition unit in accordance with claim 1, wherein the layers of the interconnector plate have a thickness of between 0.1 mm and 1 mm.

11. A repetition unit in accordance with claim 1, wherein a cathode substrate, an electrolyte substrate, an anode substrate or an additional porous metal substrate serves as a carrier for the cathode-electrolyte-anode unit.

12. A stack arrangement of electrochemical cells, comprising at least two repetition units in accordance with claim 11.

13. A method for the manufacture of a repetition unit, the repetition unit including:
a cathode-electrolyte-anode unit; and
a first layer and at least one further layer of an interconnector plate contacting the cathode-electrolyte-anode unit, where the first layer of the interconnector plate is made from electrically conductive material and is in electrical contact with the cathode-electrolyte-anode unit, while the at least one further layer is omitted in an active region,
wherein the at least one further layer is formed from an unshaped planar material, whereby the first layer of the interconnector plate also being unshaped at least in a marginal region surrounding the active region and the cathode-electrolyte-anode unit as well as all the layers of the interconnector plate being soldered to one another in the marginal region and
the method comprises:
applying a solder paste in a marginal region to at least one of two later mutually contacting surfaces of two of the layers of the interconnector plate or of the cathode-electrolyte-anode unit;
applying a solder paste to an interconnector plate layer; and
pre-installing the layers of the interconnector plate and the cathode-electrolyte-anode unit by placing them onto one another, with the layers of the interconnector plate and the cathode-electrolyte-anode unit subsequently being soldered to one another by common heating.

14. A method in accordance with claim 13, wherein the layers of the interconnector plate and the cathode-electrolyte-anode unit are heated for soldering to a temperature of between about 600° C. and 1100° C.

15. A method in accordance with claim 13, wherein designated recesses and cut-outs in the layers of the interconnector plate are cut out or punched out previously.
